(19) United States
(12) Patent Application Publication
(10) Pub. No.: US 2008/0181148 A1
(43) Pub. Date: Jul. 31, 2008

(54) Multi-node media content relay system

(75) Inventors: Kah Yong Lee, Singapore (SG); Chee Oei Chan, Singapore (SG); Beng Huat Chua, Singapore (SG)

Correspondence Address: SAILE ACKERMAN LLC, 28 DAVIS AVENUE, POUGHKEEPSIE, NY, 12603, US

(73) Assignee: FreeSystems Pte., Ltd.

(21) Appl. No.: 12/006,953

(22) Filed: Jan. 8, 2008

Related U.S. Application Data
(60) Provisional application No. 60/879,172, filed on Jan. 8, 2007.

(51) Int. Cl. H04B 7/00

(52) U.S. Cl. 370/310

(57) ABSTRACT

A serially linked digital data content relaying system that wirelessly transfers digital data content files such digital audio files, digital video files, or digital voice paging files includes a virtual serial network. The virtual serial network includes a master controller node device and multiple reproduction node devices. The master controller node device maintains digital data content files for distribution through the virtual serial network of the digital data content relaying system to the reproduction node devices. Each reproduction node device is serially in wireless communication two reproduction node devices that are in close proximity. A first reproduction node device of the plurality of reproduction node devices is in wireless communication with the master controller server to receive the digital data content files as radio frequency signals.

This application claims priority under 35 U.S.C. §119 to U.S. Provisional Patent Application Ser. No. 60/879,172, Filing Date: Jan. 8, 2007 which is herein incorporated by reference in its entirety.

### RELATED PATENT APPLICATIONS

“A Multi-Node Media Content Distribution System”, Number Ser. No. 60/879,173, Filing Date: Jan. 8, 2007, assigned to the same assignee as this invention and incorporated herein by reference in its entirety.

“A Wireless Network for Personal Computer Human Interface Devices”, Number Ser. No. 60/879,174, Filing Date: Jan. 8, 2007, assigned to the same assignee as this invention and incorporated herein by reference in its entirety.

### FIELD OF THE INVENTION

This invention relates generally to data network systems. More particularly this invention relates to serially communicating network systems for the transfer of media content from a master control node to remote nodes of the network.

### DESCRIPTION OF RELATED ART

Wireless networks such as the Bluetooth network allow the communication between portable and remote electronic devices, such as notebook computers, mobile phones, PDAs, digital cameras, and mp3/MD/DVD players. Digital media content files such as digitized audio (music and voice) and video files are transferred between the portable and remote electronic devices.

“Bluetooth: An Enabler for Personal Area Networking”, Johansson, et al., IEEE Network, September/October 2001, Vol.: 15, Issue: 5, pp.: 28-37, describes use of portable electronic devices in a network of personal devices that is often referred to as a personal area network. The Bluetooth piconet network architecture, a strict star topology, is extended into a scatternet architecture, where piconets are interconnected. A consequence of creating scatternet-based personal area networks is that some nodes will form gateways between piconets, and these gateways must be capable of time sharing their presence in each piconet of which they are members. Johansson et al. presents an overall architecture for handling scheduling in a scatternet. A family of feasible interpiconet scheduling algorithms, referred to as rendezvous point algorithms, is also introduced and discussed.

“Bluenet—A New Scatternet Formation Scheme”, Wang et al., Proceedings of the 35th Annual Hawaii International Conference on System Sciences, IEE Computer Society, January 2002, 9 pages (not numbered), presents a scheme for building an efficient scatternet and discusses the basic rules of the scheme. Two methods are introduced to evaluate the performance of the resulting scatternets based on average shortest path length and maximum traffic flows respectively.

“Interconnecting Bluetooth-like Personal Area Networks”, Tan, 1st Annual Oxygen Workshop, Gloucester, Mass., 2001, found Feb. 1, 2007 at http://nms.csail.mit.edu/projects/blueware/oxygen01.pdf, identifies the three main challenges in interconnecting multiple Bluetooth-like PANs: scatternet topology formation, packet routing, and channel or link scheduling. The need for an explicit topology formation process stems from the fact that devices need to discover each other and explicitly establish a point-to-point link to synchronize the frequency hopping sequence and exchange signaling information. Once the scatternet is formed, some mechanism is required to efficiently route packets across multiple PANs. The scheduling problem arises because channel bandwidth must be used efficiently, and the time division duplex nature introduces problems not seen in traditional wireless channel scheduling. “A Priority Control Method for Wireless Multi-Hop Access Using IEEE 802.11 DCF Mechanism” Kawamura, et al., 15th IEEE International Symposium on Personal, Indoor and Mobile Radio Communications, 2004, PIMRC 2004, September 2004, Vol.: 1, pp.: 520-524 explains the problem of throughput degradation of a relay station when IEEE 802.11 is adopted in multi-hop communications. The relay stations lose some of their capacity compared to stations that are not relaying the data of other stations. Because all stations, have equal transmission opportunity, the relay stations have to send packets from other terminals. An autonomous priority control method is proposed that changes the contention window size depending on the number of relay stations and the number of hops to ensure that relay stations are offered the same transmission capacity as regular stations in the service area.

“Relay-Based Deployment Concepts for Wireless and Mobile Broadband Radio”, Pabst, IEEE Communications Magazine, September 2004, Vol.: 42, Issue: 9, pp.: 80-89, provides a synopsis of numerous contributions to the working group 4 of the wireless world research forum and other research work and presents an overview of topics and applications in the context of relaying. It covers different approaches to exploiting the benefits of multihop communications via relays, such as solutions for radio range extension in mobile and wireless broadband cellular networks (trading range for capacity), and solutions to combat shadowing at high radio frequencies. Furthermore, relaying is presented as a means to reduce infrastructure deployment costs. It is also shown that through the exploitation of spatial diversity, multihop relaying can enhance capacity in cellular networks.

U.S. Pat. No. 6,256,303 (Drakoulis, et al.) describes a wireless broadcast link to remote receiver that includes a transmitter for transmitting received signals from a signal source as a modulated signal on a high frequency 900 MHz carrier to a remote receiver. The remote receiver converts the high frequency carrier in at least one conversion step to a lower frequency carrier signal. The lower frequency carrier signal carrying the modulated signal is then converted to another carrier signal and retransmitted as a modulated second signal to another remote receiver capable of demodulating the signal and broadcasting the audio sounds or video images.

U.S. Pat. No. 6,690,657 (Lau, et al.) provides a multichannel distributed wireless repeater network. The network is designed to facilitate high-bit-rate data communication within a home, office, or similarly constrained area. RF radiation outside of the desired network area can be minimized by use of low power transmitter and repeaters, while short paths and uniform signal strength within the network area predominate, facilitating high bit rates. The network utilizes low-power RF transmitters that generally have insufficient power to reliably span the entire network of receivers. To provide uniform coverage throughout the network, channel-shifting repeaters are used. These repeaters pick up a transmitted (or retransmitted) signal on one channel, shift it to a substantially non-interfering channel, and retransmit the signal. The receivers can receive signals on the best available channel, whether it is the original channel or a repeating channel.

U.S. Pat. No. 6,728,541 (Ohkura, et al.) describes a radio relay system where a plurality of radio relay stations are connected so that bi-directional ring-like paths are made up of radio transmission paths. The respective radio relay stations bidirectionally transmit data inputted from terminals onto the bidirectional ring-like paths respectively. The respective data are respectively received by radio relay stations having data destination terminals along the bidirectional ring-like paths. Each radio relay station, which has received the data destined for the terminals from both directions, transmits earlier incoming data to each terminal. The radio relay system is capable of relaying data with a high degree of reliability.

U.S. Pat. No. 7,002,933 (Poon, et al.) illustrates a wireless mobile network with an adaptive locally linked mobile network for locally routing multimedia content. The wireless mobile communication network allows mobile, nodes, such as cellular telephone, and other types of mobile transceivers, to communicate with a fixed base station and directly with one another. This mobile to mobile communication capability is exploited through the formation of a local link where nodes with excess processing and bandwidth capacity forward messages at the request of the base station. The formation of the local link is adaptive and does not require a central controller. Nodes are configured as major nodes when they communicate information directly with the base station via a network link. Nodes are configured as minor nodes when they communicate the information indirectly with the base station via a direct local link with one of the major nodes to form a locally linked mobile network within the wireless mobile communications network.

U.S. Pat. No. 7,043,252 (Khitrik, et al.) describes an information transmission method for a wireless local network. The wireless local area network (WLAN) includes multiple transceivers capable of establishing communication with one another (i.e. operating in a peer-to-peer mode). The method determines the quality of communication between all transceivers and storage of communication quality data by each of the transceivers. Based on stored data on communication quality, a transceiver operating in the transmission mode transmits information to an addressee by a transmission route that provides for the quality of communication, which is equal to or better than a specified threshold value of communication quality.

U.S. Pat. No. 7,046,168 (Tsuboi) provides an inter-vehicle communication method that performs communication by sequentially relaying transmission information among vehicles. For broadcasting the transmission information to peripheral vehicles, a vehicle transmitting the transmission information designates relay vehicles and causes the relay vehicles to broadcast reception information to peripheral vehicles of the relay vehicles. In order to designate the relay vehicles, the vehicle transmitting the transmission information receives positional information from its peripheral vehicles, identifies branch roads on which the respective peripheral vehicles exist by referring to map information, and designates as relay vehicles peripheral vehicles farthest away from the vehicle transmitting the transmission information on the respective branch roads.

U.S. Pat. No. 7,092,434 (Moon, et al.) teaches a mobile station that is used as a repeater station when communicating with a base station. When a mobile station communicates with a base station by way of one or a plurality of other mobile stations, the mobile station acting as a relay station determines whether the data demodulated after being received is reception data for the mobile station or transfer data to be transmitted to the other mobile station or the base station. It then decides a modulation mode suitable for transmitting the transfer data and transmission data if the transmission data is generated in the mobile station. The base station demodulates a reception signal relayed by the mobile stations according to the modulation mode of the mobile station having directly communicated with the base station, and identifies each user data multiplexed.

U.S. Pat. No. 7,106,819 (Kaewell, Jr., et al.) illustrates a wireless digital telephone system containing at least one emulated base station plus one or more subscriber stations. The emulated base station comprises a station similar to the subscriber station but having the capability of initiating a synchronization process whereby it is enabled to assign time slots to the subscriber station within the frame pattern of an amplitude signal by means of monitoring for positive edges in the signal.

U.S. Patent Application 2005/0286546 Bassoli, et al. describes methods and apparatus for providing synchronous playback of the same piece of time-based media on multiple devices connected over heterogenous channels consisting of varying degrees of delay. The apparatus employs a peer-to-peer wireless application that allows users to share music locally through handheld devices. Users can “tune in” to other nearby music players and listen to the digital music of the nearby players. The players provide access to their profile and playlist information, and enables synchronized peer-to-peer audio streaming. The wireless applications are based on wireless local area networks based on specifications such as Bluetooth or IEEE 802.11.

### SUMMARY OF THE INVENTION

An object of this invention is to provide a virtual serial network that allows communication of a master controller node device with multiple reproduction node devices to transfer digital media content files throughout the network for reproduction.

To accomplish at least this object, a serially linked digital data content relaying system has a virtual serial network. The virtual serial network includes a master controller node device and multiple reproduction node devices. The master controller node device maintains digital data content files for distribution through the virtual serial network of the digital data content relaying system to the reproduction node devices. Each reproduction node device is serially in wireless communication two reproduction node devices that are in close proximity. A first reproduction node device of the plurality of reproduction node devices is in wireless communication with the master controller server to receive the digital data content files as radio frequency signals. Each of the reproduction node devices wirelessly transfers the digital data content files as radio frequency signals sequentially from one reproduction node device to a next reproduction node device of the virtual serial network. The digital data content files are digital audio files, digital video files, or digital voice paging files.

In the virtual serial network, a newly added reproduction node device transmits an identity code to at least one of the plurality of reproduction node devices. The identity code is then transferred to the master controller node device. The master controller node device assigns a serial position of the newly added reproduction node device such that the newly added reproduction node device receives digital data content files as radio frequency signals from a preceding reproduction node device and transmits the digital data content files as radio frequency signals to a succeeding reproduction node devices reproduction node device.

The master controller node device incorporates a baseband control circuit to format and condition the digital data content files. A digital data content storage device is in communication with the baseband control circuit to receive, store, fetch, and transmit the digital data content files. The digital data content storage device is a magnetic disk, a volatile random access memory, a nonvolatile random access memory, or an optical storage disk. A master control unit schedules transmission and reproduction of the digital data content files and structures the locations of the reproduction node devices within the virtual serial network. The master controller node device has a transceiver in communication with the baseband control circuit to obtain the digital data content files for transmission as radio frequency signals to the first reproduction node.

The master controller node device further includes an antenna connected to the transceiver to transmit and receive the radio frequency signals including encoded digital data content files. A speaker is included in the master controller node device to reproduce audio signals decoded from the digital data content files and a microphone to receive audio signals for conversion to the digital data content files.

Similarly, each of the plurality of reproduction node devices has a baseband control circuit to format and condition the digital data content files. A digital data content storage device in communication with the baseband control circuit to receive, store, fetch, and transmit the digital data content files. A master control unit schedules reproduction of the digital data content files at the within the reproduction node device and schedules transmission of the digital data content files to the succeeding reproduction node devices within the virtual serial network. A transceiver is in communication with the baseband control circuit to obtain the digital data content files for transmission as the radio frequency signals to a succeeding adjacent reproduction node and to store the data content files as the radio frequency signals received from a preceeding adjacent reproduction node. The digital data content storage device is a magnetic disk, a volatile random access memory, a nonvolatile random access memory, or an optical storage disk.

Each of the plurality of reproduction node devices further incorporates an antenna connected to the transceiver to transmit and receive the radio frequency signals including encoded digital data content files. Each of the plurality of reproduction node devices further has a speaker to reproduce audio signals decoded from the digital data content files and microphone to receive audio signals for conversion to the digital data content files.

The radio frequency signals are the digital data content files and control instruction data. The digital data content files are transferred from the master controller node device to the first reproduction node device and sequentially to each of the succeeding reproduction node devices. The control instruction data is transferred bi-directionally between each of the plurality of reproduction node devices and the master controller node device to provide instructions for requesting, transferring, and presenting of the digital data content files.

### BRIEF DESCRIPTION OF THE DRAWINGS

FIG. 1 is a block diagram of the multi-node media content relay system of this invention.

FIG. 2 is a block diagram of the master content control circuit of the multi-node media content relay system of this invention.

FIG. 3 is a block diagram a reproduction node device of the multi-node media content relay system of this invention.

### DETAILED DESCRIPTION OF THE INVENTION

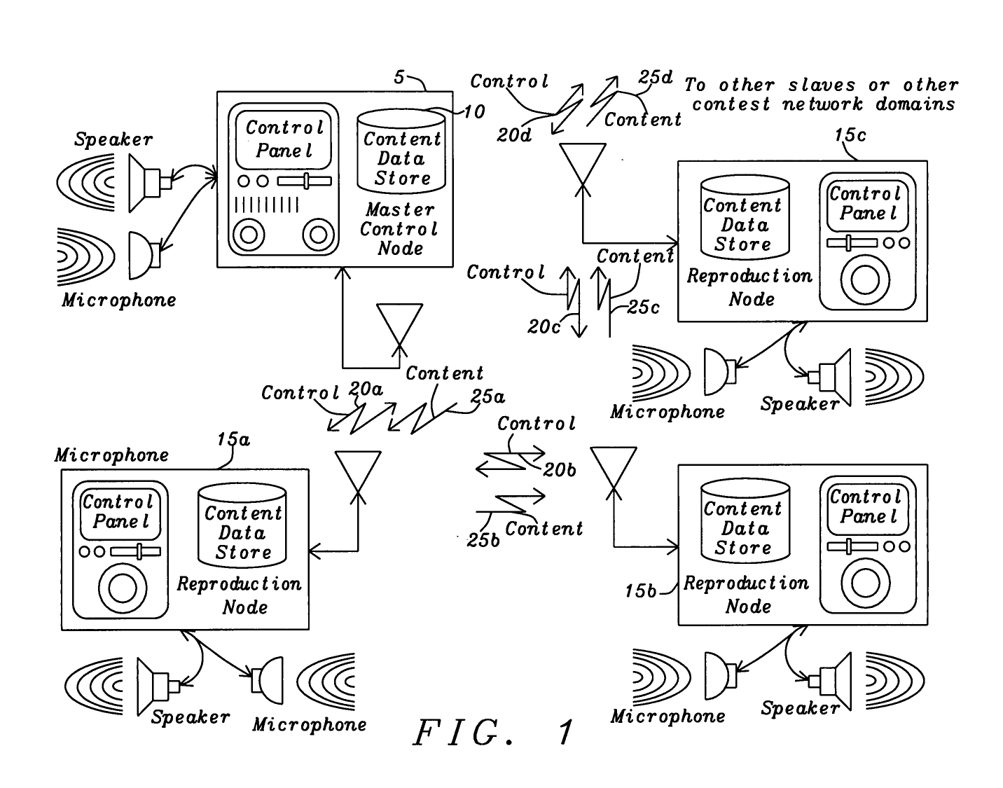

Refer to FIG. 1 for a description of a multi-node media content relay system that transfers digital information, such as audio, wirelessly from one node to others in a virtual serial network. A master control node 5 has a content data storage device 10 either resident within it or in communication with the master control node 5. The content data storage device 10 retains the digital media data such as digital audio or digital video files.

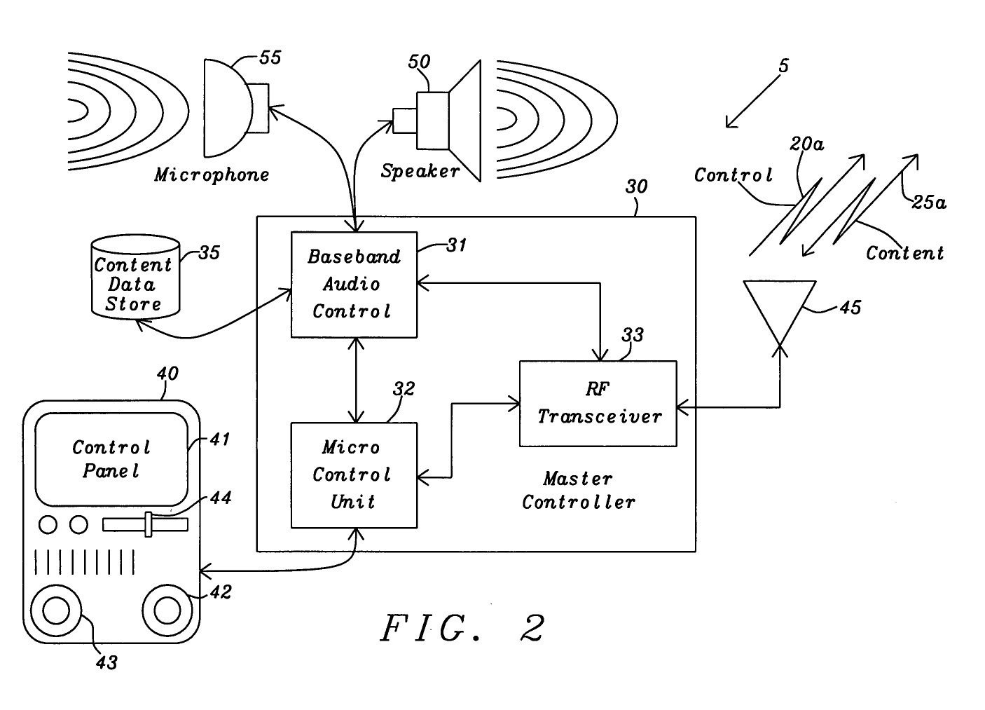

The master control node 5, as shown in FIG. 2, has a baseband control circuit 31 to format and condition the digital data content files. The base band control circuit is in communication with a digital data content storage device 35 to receive, store, fetch, and transmit the digital data content files. The master control unit 32 is further in communication the baseband audio control circuit 31 to schedule transmission and reproduction of the digital data content files. An RF transceiver 33 is in communication with the baseband control circuit to obtain the digital data content files for transmission as radio frequency signals 20a and 25a to the first reproduction node.

The master control node 5 has a control panel 40 that provides the necessary physical controls to allow a human interface to the master controller 32. The control panel 40 has a display panel 41 for displaying the necessary control information for use by a person operating the master control node 5. The control panel 40 further includes control knobs and levers 42, 43, and 44 for providing the necessary control instructions to the master control node 30.

It should be noted that the display panel 41 may also be used for the display of the digital media content files if those files are video files. The control knobs and levers 42, 43, and 44 provide the necessary controls for selecting and scheduling the digital media content files for broadcast and reproduction, for adjusting the audio volume, and other similar necessary control function.

The master control node 5 has a speaker 50 for local reproduction of audio from the digital media content files and a microphone 55 for reception of voice and/or music for creation of the digital media content files. In this instance the digital media content files maybe audio files or paging files for the transmission of voice paging messages to the reproduction nodes 15a, 15b, and 15c.

The transceiver 33 is connected to an antenna 45 to transmit and receive the radio frequency signals including encoded digital data content files. The radio frequency signals include digital data content files 25a and control instruction data 20a. The digital data content files are encoded and modulate the radio frequency signals 25a for transfer from the master controller node 5 device to the first reproduction node device 15a of FIG. 1. The control instruction data are encoded and modulate the radio frequency signals 20a for transfer bi-directionally between each of the plurality of reproduction node 15a, 15b, and 15c and the master controller node device 5 to provide instructions for requesting, transferring, and presenting of the digital data content files.

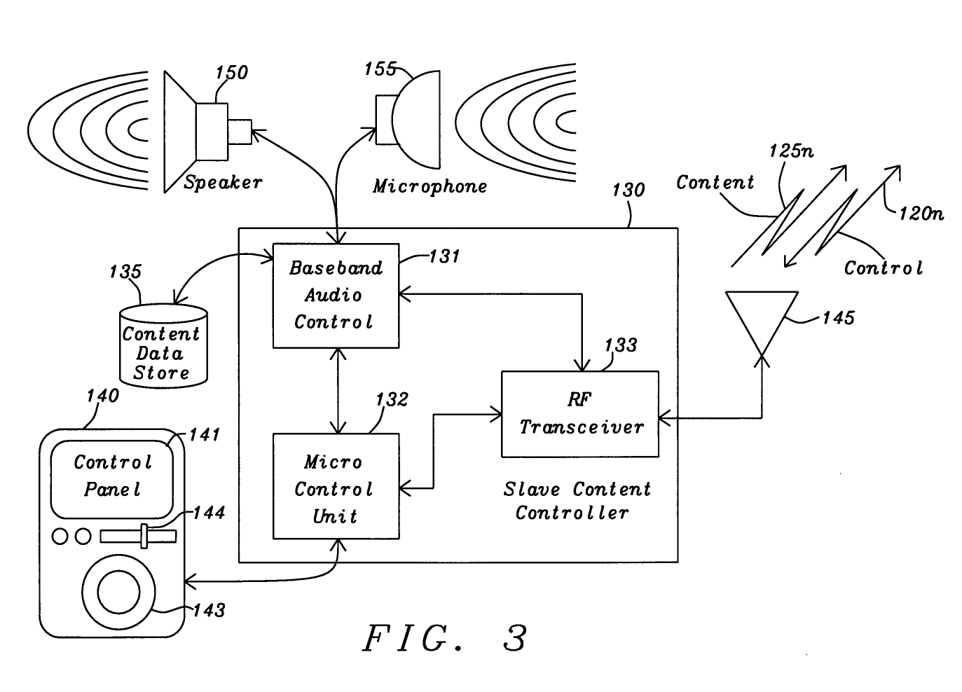

The master control node 5 is in communication with a reproduction node 15a which in turn is in communication with a second reproduction node 15b which in turn is in communication with a third reproduction node 15c. Other nodes may be connected in this virtual serial network implementing a “daisy-chained” structure. Refer now to FIG. 3 for a discussion of the structure of the reproduction node 15. The reproduction node 15 has a baseband control circuit 131 to format and condition the digital data content files. The base band control circuit is in communication with a digital data content storage device 135 to receive, store, fetch, and transmit the digital data content files. A micro control unit 132 is further in communication the baseband audio control circuit 131 to schedule transmission and reproduction of the digital data content files to succeeding reproduction nodes of the virtual serial network. An RF transceiver 133 is in communication with the baseband control circuit 131 to obtain the digital data content files for transmission as radio frequency signals 20n and 25n to the succeeding reproduction nodes.

The reproduction node 15 has a control panel 140 that provides the necessary physical controls to allow a human interface to the micro controller 132. The control panel 140 has a display panel 141 for displaying the necessary control information for use by a person operating the reproduction node 15a, 15b, and 15c. The control panel 140 further includes control knobs and levers 143 and 144 for providing the necessary control instructions to the master control node 130.

It should be noted that the display panel 141 may also be used for the display of the digital media content files if those files are video files. The control knobs and levers 143 and 144 provide the necessary controls for selecting and scheduling the digital media content files for broadcast and reproduction, for adjusting the audio volume, and other similar necessary control function.

The reproduction node 15 has a speaker 150 for local reproduction of audio from the digital media content files and a microphone 155 for reception of voice and/or music for creation of the digital media content files. In this instance the digital media content files maybe audio files or paging files for the transmission of voice or text paging messages to the reproduction nodes 15.

The transceiver 133 is connected to an antenna 145 to transmit and receive the radio frequency signals 20n and 25n including encoded digital data content files. The radio frequency signals include digital data content files 125a and control instruction data 120a. The digital data content files are encoded and modulate the radio frequency signals 125n for transfer from the one reproduction node device 15a, 15b, and 15c to a succeeding reproduction node device reproduction node device 15a, 15b, and 15c of FIG. 1. The control instruction data are encoded and modulate the radio frequency signals 120n for transfer bi-directionally between each of the plurality of reproduction node devices 15a, 15b, and 15c and the master controller node device 5 to provide instructions for requesting, transferring, and presenting of the digital data content files.

Returning to FIG. 1, when a reproduction node device 15a, 15b, and 15c is to be added to the virtual serial network, it transmits an identity code embedded in the control signals 20a, 20b, 20c and 20d to at least one of the reproduction node devices 15a, 15b, and 15c or the master controller node device 5. The control signals 20a, 20b, 20c and 20d with the identity code are transferred to the master controller node device 5 from the reproduction node devices 15a, 15b, and 15c. The master controller node device 5 assigns a serial position of the newly added reproduction node device 15a, 15b, and 15c by the control signals 20a, 20b, 20c and 20d. The newly added reproduction node device 15a, 15b, and 15c now receives digital data content files as radio frequency signals 25a, 25b, 25c and 25d from a preceding reproduction node device 15a, 15b, and 15c and transmits the digital data content files as radio frequency signals 20a and 25a to a succeeding reproduction node device 15a, 15b, and 15c.

In operation, the content data is extracted from the content data storage device 10. The master control node 5 then formats the content data to append necessary command and control data to the content data. The content data is transmitted from the master control node 5 to the first reproduction node 15a as the content RF signals 25a. The content data 25b is then relayed to the second reproduction node 15b, which in turn is relayed as the content data 15c to the third reproduction node 15c as the content RF signals 25b. The content data from the third reproduction node 15c is relayed to other nodes in the network through the intermediate nodes or to other network domains beyond the limits of the RF transmission of the master control node 5.

The master control node 5 and each of the reproduction node 15a, 15b, and 15c may transmit using the same carrier frequency but in different time slots in order to avoid inter-node interference. Alternatively, the master control node 5 and each of the reproduction node 15a, 15b, and 15c can also receive the content and relay it in different RF channels.

Each of the master control node 5 and each of the reproduction nodes 15a, 15b, and 15c may playback the content data being wirelessly relayed through each of the reproduction nodes 15a, 15b, and 15c and the other network domains beyond the limits of the RF transmission of the master control node 5. This is a “daisy-chain” organization where the content is broadcast serially from the master control node 5 to each of the reproduction node 15a, 15b, and 15c.

Further, the multi-node media content relay system supports transmission of bidirectional digital control data between the master control node 5 and each of the reproduction nodes 15a, 15b, and 15c. More than one of the reproduction nodes 15a, 15b, and 15c may transmit control information 20a, 20b, 20c, 20d to the master control node 5 using back-off and retry mechanism. In addition to relaying the digital data content files such as digital audio and video to the daisy-chained reproduction nodes 15a, 15b, and 15c, the multi-node media content relay system of this invention can also provide a paging function (contacting a person in close proximity to one of the reproduction nodes 15a, 15b, and 15c). The originator of the paging information can come from any of the master control node 5 or each of the reproduction nodes 15a, 15b, and 15c. Further, the paging information may be broadcasted to all the master control node 5 and each of the reproduction nodes 15a, 15b, and 15c.

The master control node 5 and each of the reproduction nodes 15a, 15b, and 15c are assigned a unique identification codes that are appended with the control information to identify the source and destination of the control information. Further, the master control node 5 will also control where the content data is to be played back by appending the unique identifiers code to the on the content data 25a. All nodes will relay the content data but will only play back the content if the matching unique identification code is found.

It should be noted that since this is a daisy-chain (broadcast/relay) network structure, one of the reproduction nodes 16a, 15b, and 15c will receive from one neighboring preceding reproduction node 15a, 15b, and 15c only but it will be able to relay the information to multiple succeeding neighboring reproduction nodes 15a, 15b, and 15c.

If one of the reproduction nodes 15a, 15b, and 15c is disabled, the whole network is not disabled since the structure of the network is essentially a mesh structure with the “daisy-chained” virtual serial network imposed upon the underlying network. When one of the intermediate reproduction nodes 15a, 15b, and 15c is disabled, its “children” will scan for new “parent”. If it detects a signal within the close proximity, it will rejoin the network and start relaying the content.

Inter-node interference between the master control node 5 and each of the reproduction nodes 15a, 15b, and 15c is avoided by using time division multiple access (tdma) when the nodes are using the same RF carrier or alternatively the neighboring nodes will transmit the content in separate RF channels.

While this invention has been particularly shown and described with reference to the preferred embodiments thereof, it will be understood by those skilled in the art that various changes in form and details may be made without departing from the spirit and scope of the invention.

The invention claimed is:

1. A serially linked digital data content relaying system comprising:
a virtual serial network comprising:
a master controller node device that maintains digital data content files for distribution through the digital data content relaying system; and
a plurality of reproduction node devices,
wherein each reproduction node device is serially in wireless communication with two reproduction node devices that are in close proximity,
wherein a first reproduction node device of the plurality of reproduction node devices is in wireless communication with the master controller server to receive the digital data content files as radio frequency signals, and
wherein each of the reproduction node devices wirelessly transfers the digital data content files as radio frequency signals sequentially from one reproduction node device to a next reproduction node device of the virtual serial network.

2. The serially linked digital data content relaying system of claim 1 wherein in the virtual serial network, a newly added reproduction node device transmits an identity code to at least one of the plurality of reproduction node devices, the identity code being transferred to the master controller node device, the master controller node device assigning a serial position of the newly added reproduction node device such that the newly added reproduction node devices receives digital data content files as radio frequency signals from a preceding reproduction node device and transmits the digital data content files as radio frequency signals to a succeeding reproduction node devices reproduction node device.

3. The serially linked digital data content relaying system of claim 1 wherein the digital data content files are digital audio files, digital video files, or digital voice paging files.

4. The serially linked digital data content relaying system of claim 1 wherein the master controller node device comprises
a baseband control circuit to format and condition the digital data content files;
a digital data content storage device in communication with the baseband control circuit to receive, store, fetch, and transmit the digital data content files;
a master control unit to schedule transmission and reproduction of the digital data content files; and
a transceiver in communication with the baseband control circuit to obtain the digital data content files for transmission as radio frequency signals to the first reproduction node.

5. The serially linked digital data content relaying system of claim 1 wherein the master controller node device further comprises an antenna connected to the transceiver to transmit and receive the radio frequency signals including encoded digital data content files.

6. The serially linked digital data content relaying system of claim 1 wherein the master controller node device further comprises a speaker to reproduce audio signals decoded from the digital data content files.

7. The serially linked digital data content relaying system of claim 1 wherein the master controller node device further comprises a microphone to receive audio signals for conversion to the digital data content files.

8. The serially linked digital data content relaying system of claim 4 wherein the digital data content storage device is a magnetic disk, a volatile random access memory, a nonvolatile random access memory, or an optical storage disk.

9. The serially linked digital data content relaying system of claim 1 wherein the each of the plurality of reproduction node devices comprises
a baseband control circuit to format and condition the digital data content files;
a digital data content storage device in communication with the baseband control circuit to receive, store, fetch, and transmit the digital data content files;
a master control unit to schedule transmission and reproduction of the digital data content files; and
a transceiver in communication with the baseband control circuit to obtain the digital data content files for transmission as the radio frequency signals to a succeeding adjacent reproduction node and to store the data content files as the radio frequency signals received from a preceeding adjacent reproduction node.

10. The serially linked digital data content relaying system of claim 1 wherein the each of the plurality of reproduction node devices further comprises an antenna connected to the transceiver to transmit and receive the radio frequency signals including encoded digital data content files.

11. The serially linked digital data content relaying system of claim 1 wherein the each of the plurality of reproduction node devices further comprises a speaker to reproduce audio signals decoded from the digital data content files.

12. The serially linked digital data content relaying system of claim 1 wherein the each of the plurality of reproduction node devices further comprises a microphone to receive audio signals for conversion to the digital data content files.

13. The serially linked digital data content relaying system of claim 9 wherein the digital data content storage device is a magnetic disk, a volatile random access memory, a nonvolatile random access memory, or an optical storage disk.

14. The serially linked digital data content relaying system of claim 1 wherein the radio frequency signals comprise:
the digital data content files transferred from the master controller node device to the first reproduction node device and sequentially to each of the succeeding reproduction node devices; and
control instruction data transferred bi-directionally between each of the plurality of reproduction node devices and the master controller node device to provide instructions for requesting, transferring, and presenting of the digital data content files.

15. A virtual serial network comprising:
a master controller node device that maintains digital data content files for distribution through the virtual serial network; and
a plurality of reproduction node devices, each of the reproduction node devices communicating with at least one other of the plurality of reproduction node devices or the master controller node device;
wherein each reproduction node device is serially in wireless communication with reproduction node devices that are in close proximity,
wherein a first reproduction node device of the plurality of reproduction node devices is in wireless communication with the master controller server to receive the digital data content files as radio frequency signals, and
wherein each of the reproduction node devices wirelessly transfers the digital data content files as radio frequency signals sequentially from one reproduction node device to a next reproduction node device of the virtual serial network.

16. The virtual serial network of claim 15 wherein a newly added reproduction node device transmits an identity code to at least one of the plurality of reproduction node devices, the identity code being transferred to the master controller node device, the master controller node device assigning a serial position of the newly added reproduction node device such that the newly added reproduction node devices receives digital data content files as radio frequency signals from a preceding reproduction node device and transmits the digital data content files as radio frequency signals to a succeeding reproduction node devices reproduction node device.

17. The virtual serial network of claim 15 wherein the digital data content files are digital audio files, digital video files, or digital voice paging files.

18. The virtual serial network of claim 15 wherein the master controller node device comprises
a baseband control circuit to format and condition the digital data content files;
a digital data content storage device in communication with the baseband control circuit to receive, store, fetch, and transmit the digital data content files;
a master control unit to schedule transmission and reproduction of the digital data content files; and
a transceiver in communication with the baseband control circuit to obtain the digital data content files for transmission as radio frequency signals to the first reproduction node.

19. The virtual serial network of claim 15 wherein the master controller node device further comprises an antenna connected to the transceiver to transmit and receive the radio frequency signals including encoded digital data content files.

20. The virtual serial network of claim 15 wherein the master controller node device further comprises a speaker to reproduce audio signals decoded from the digital data content files.

21. The virtual serial network of claim 15 wherein the master controller node device further comprises a microphone to receive audio signals for conversion to the digital data content files.

22. The virtual serial network of claim 8 wherein the digital data content storage device is a magnetic disk, a volatile random access memory, a nonvolatile random access memory, or an optical storage disk.

23. The virtual serial network of claim 15 wherein the each of the plurality of reproduction node devices comprises
a baseband control circuit to format and condition the digital data content files;
a digital data content storage device in communication with the baseband control circuit to receive, store, fetch, and transmit the digital data content files;
a master control unit to schedule transmission and reproduction of the digital data content files; and
a transceiver in communication with the baseband control circuit to obtain the digital data content files for transmission as the radio frequency signals to a succeeding adjacent reproduction node and to store the data content files as the radio frequency signals received from a preceeding adjacent reproduction node.

24. The virtual serial network of claim 15 wherein the each of the plurality of reproduction node devices further comprises an antenna connected to the transceiver to transmit and receive the radio frequency signals including encoded digital data content files.

25. The virtual serial network of claim 15 wherein the each of the plurality of reproduction node devices further comprises a speaker to reproduce audio signals decoded from the digital data content files.

26. The virtual serial network of claim 15 wherein the each of the plurality of reproduction node devices further comprises a microphone to receive audio signals for conversion to the digital data content files.

27. The virtual serial network of claim 23 wherein the digital data content storage device is a magnetic disk, a volatile random access memory, a nonvolatile random access memory, or an optical storage disk.

28. The virtual serial network of claim 15 wherein the radio frequency signals comprise:
the digital data content files transferred from the master controller node device to the first reproduction node device and sequentially to each of the succeeding reproduction node devices; and
control instruction data transferred bi-directionally between each of the plurality of reproduction node devices and the master controller node device to provide instructions for requesting, transferring, and presenting of the digital data content files.

29. A method for forming a virtual serial network comprising the steps of:
providing a master controller node device that maintains digital data content files for distribution through the virtual serial network; and
providing a plurality of reproduction node devices, each of the reproduction node devices communicating with at least one other of the plurality of reproduction node devices or the master controller node device;
communicating wirelessly of each reproduction node device serially with reproduction node devices that are in close proximity,
communicating wirelessly by a first reproduction node device of the plurality of reproduction node devices with the master controller server to receive the digital data content files as radio frequency signals, and
transferring the digital data content files as radio frequency signals by each of the reproduction node devices wirelessly and sequentially from one reproduction node device to a next reproduction node device of the virtual serial network.

30. The method for forming the virtual serial network of claim 29 further comprising the step of:
transmitting by a newly added reproduction node device an identity code to at least one of the plurality of reproduction node devices;
transferring the identity code to the master controller node device;
assigning a serial position of the newly added reproduction node device by the master controller node device;
receiving digital data content files as radio frequency signals by the newly added reproduction node device from a preceding reproduction node device; and
transmitting the digital data content files as radio frequency signals by the newly added reproduction node device to a succeeding reproduction node devices reproduction node device.

31. The method for forming the virtual serial network of claim 29 wherein the digital data content files are digital audio files, digital video files, or digital voice paging files.

32. The method for forming the virtual serial network of claim 29 wherein providing the master controller node device comprises the steps of:
providing a baseband control circuit to format and condition the digital data content files;
providing a digital data content storage device in communication with the baseband control circuit to receive, store, fetch, and transmit the digital data content files;
providing a master control unit to schedule transmission and reproduction of the digital data content files; and
providing a transceiver in communication with the baseband control circuit to obtain the digital data content files for transmission as radio frequency signals to the first reproduction node.

33. The method for forming the virtual serial network of claim 29 wherein providing the master controller node device further comprises the step of providing an antenna connected to the transceiver to transmit and receive the radio frequency signals including encoded digital data content files.

34. The method for forming the virtual serial network of claim 29 wherein providing the master controller node device further comprises the step of providing a speaker to reproduce audio signals decoded from the digital data content files.

35. The method for forming the virtual serial network of claim 29 wherein providing the master controller node device further comprises the step of providing a microphone to receive audio signals for conversion to the digital data content files.

36. The method for forming the virtual serial network of claim 32 wherein the digital data content storage device is a magnetic disk, a volatile random access memory, a nonvolatile random access memory, or an optical storage disk.

37. The method for forming the virtual serial network of claim 29 wherein providing the each of the plurality of reproduction node devices comprises the steps of:
providing a baseband control circuit to format and condition the digital data content files;
providing a digital data content storage device in communication with the baseband control circuit to receive, store, fetch, and transmit the digital data content files;
providing a master control unit to schedule transmission and reproduction of the digital data content files; and
providing a transceiver in communication with the baseband control circuit to obtain the digital data content files for transmission as the radio frequency signals to a succeeding adjacent reproduction node and to store the data content files as the radio frequency signals received from a preceeding adjacent reproduction node.

38. The method for forming the virtual serial network of claim 29 wherein providing the each of the plurality of reproduction node devices further comprises the steps of providing an antenna connected to the transceiver to transmit and receive the radio frequency signals including encoded digital data content files.

39. The method for forming the virtual serial network of claim 29 wherein providing each of the plurality of reproduction node devices further comprises the step of providing a speaker to reproduce audio signals decoded from the digital data content files.

40. The method for forming the virtual serial network of claim 29 wherein providing each of the plurality of reproduction node devices further comprises the step of providing a microphone to receive audio signals for conversion to the digital data content files.

41. The method for forming the virtual serial network of claim 37 wherein the digital data content storage device is a magnetic disk, a volatile random access memory, a nonvolatile random access memory, or an optical storage disk.

42. The method for forming the virtual serial network of claim 29 wherein the radio frequency signals comprise:
the digital data content files transferred from the master controller node device to the first reproduction node device and sequentially to each of the succeeding reproduction node devices; and
control instruction data transferred bi-directionally between each of the plurality of reproduction node devices and the master controller node device to provide instructions for requesting, transferring, and presenting of the digital data content files.
